(19) United States
(12) Patent Application Publication
(10) Pub. No.: US 2019/0359102 A1
(43) Pub. Date: Nov. 28, 2019

(54) VEHICLE SEAT

(71) Applicant: TOYOTA BOSHOKU KABUSHIKI KAISHA, Aichi-ken (JP)

(72) Inventors: Kiyoshi OSHIMA, Aichi-ken (JP); Shinji KAMIYA, Aichi-ken (JP); Yoshiyuki KUMAZAKI, Aichi-ken (JP)

(73) Assignee: TOYOTA BOSHOKU KABUSHIKI KAISHA, Aichi-ken (JP)

(21) Appl. No.: 16/418,440

(22) Filed: May 21, 2019

(30) Foreign Application Priority Data
May 24, 2018 (JP) 2018-099785

(51) Int. Cl. B60N 2/68; B60R 21/207; B60N 2/75

(52) U.S. Cl. CPC B60N 2/682; B60N 2/75; B60R 21/207; B60N 2/686

(57) ABSTRACT

A vehicle seat includes a side frame, a reinforcing frame and a collar. The side frame has a first plate-like portion constituting an outer portion of the side frame in a seat width direction, and a second plate-like portion formed to be located inward of the first plate-like portion in the seat width direction, and provided with a through hole. The collar has a tubular portion inserted in the through hole and having an end of the reinforcing frame inserted therein, and a rib-shaped portion provided at an outer end of the tubular portion in the seat width direction, and disposed outward of the second plate-like portion in the seat width direction. The tubular portion and/or the rib-shaped portion are welded to the second plate-like portion.

This nonprovisional application is based on Japanese Patent Application No. 2018-099785 filed on May 24, 2018 with the Japan Patent Office, the entire contents of which are hereby incorporated by reference.

### BACKGROUND

### Field

The present disclosure relates to a vehicle seat including a reinforcing frame.

### Description of the Background Art

As is disclosed in Japanese Patent Laying-Open No. 2017-019473, a seat frame forming a framework of a vehicle seat includes a pair of side frames, and a reinforcing frame (a reinforcing pipe in Japanese Patent Laying-Open No. 2017-019473) provided to bridge between the paired side frames.

### SUMMARY

The reinforcing frame has opposite ends fixed to the right and left side frames, respectively. Unless special consideration is given to the fixation of the ends of the reinforcing frame to the side frames, layout constraints are imposed on peripheral components. As a result, a structure for fixing the reinforcing frame to the side frames may cause an increase in width of the vehicle seat and the like.

For example, depending on the specifications of a vehicle seat, an air bag unit or an armrest (bracket) may be attached to each side frame. Unless special consideration is given, a structure for fixing a reinforcing frame to the side frames may impose layout constraints on a structure for fixing the air bag units to the side frames or a structure for fixing the armrests to the side frames. The air bag units or armrests are disposed outward in a seat width direction, which may result in an increase in width of the vehicle seat and the like.

An object of the present disclosure is to provide a vehicle seat having a configuration capable of reducing layout constraints imposed on peripheral components when fixing a reinforcing frame to side frames, as compared to conventional techniques.

A vehicle seat based on the present disclosure includes: a first side frame and a second side frame spaced from each other in a seat width direction; a reinforcing frame provided to bridge between the first side frame and the second side frame, and a collar for fixing an end of the reinforcing frame located on the first side frame side to the first side frame, the first side frame having a first plate-like portion constituting an outer portion of the first side frame in the seat width direction, and extending planarly in a direction crossing the seat width direction, and a second plate-like portion formed to be located inward of the first plate-like portion in the seat width direction, and provided with a through hole, the collar having a tubular portion inserted in the through hole and disposed to extend in the seat width direction, and having the end of the reinforcing frame inserted therein, and a rib-shaped portion provided at an outer end of the tubular portion in the seat width direction, and disposed outward of the second plate-like portion in the seat width direction, and the tubular portion and/or the rib-shaped portion being welded to the second plate-like portion.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view showing a vehicle seat 1 in a first embodiment.

FIG. 2 is a cross-sectional view taken along line II-II in a direction of arrows in FIG. 1.

FIG. 3 shows a collar 10 and the like viewed in a direction indicated by an arrow III in FIG. 2.

FIG. 4 is a cross-sectional view showing a side frame 7, collar 10 and the like included in a vehicle seat 1Z in a comparative example.

FIG. 5 is a cross-sectional view showing side frame 7, collar 10 and the like included in a vehicle seat 1A in a second embodiment.

FIG. 6 is a cross-sectional view showing side frame 7, collar 10 and the like included in a vehicle seat 1B in a third embodiment.

FIG. 7 is a cross-sectional view showing side frame 7, collar 10 and the like included in a vehicle seat 1C in a fourth embodiment.

### DESCRIPTION OF THE PREFERRED EMBODIMENTS

Embodiments are described below with reference to the drawings. In the following description, the same and corresponding components are designated by the same reference numbers and redundant description may not be repeated.

### First Embodiment

### (Vehicle Seat 1)

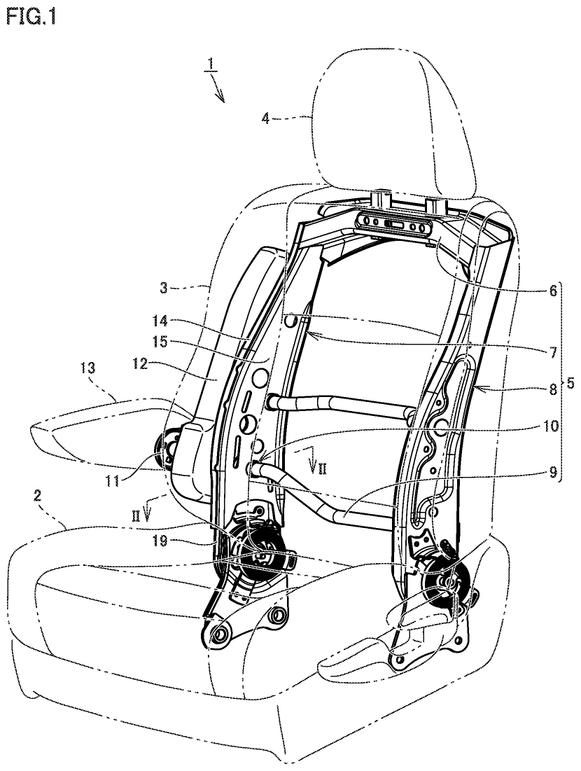

FIG. 1 is a perspective view showing a vehicle seat 1. Vehicle seat 1 functions as a car seat. Vehicle seat 1 includes a seat cushion 2, a seat back 3, a headrest 4, a seat back frame 5, an armrest holding bracket 11, an air bag unit 12, and an armrest 13.

Seat cushion 2 forms a sitting surface on its upper surface, and seat back 3 forms a backrest surface on its front surface. Headrest 4 is provided on the top of seat back 3. Seat back frame 5 forms a framework of seat back 3. Seat back frame 5 includes an upper frame 6, a side frame 7 (first side frame), a side frame 8 (second side frame), a reinforcing frame 9, and a collar 10.

Side frames 7 and 8 each have a shape extending in an upward-downward direction, and are spaced from each other in a seat width direction. Upper frame 6 is provided to connect an upper end of side frame 7 and an upper end of side frame 8. Side frames 7 and 8 form a substantially reversed U-shape together with upper frame 6, and constitute back frame 5 together with upper frame 6.

Reinforcing frame 9 is provided to bridge between side frames 7 and 8. Reinforcing frame 9 is made of iron, for example. Reinforcing frame 9 has a cylindrical shape extending in the seat width direction, and is curved or bent at appropriate positions as needed. While FIG. 1 shows two reinforcing frames 9, there may be provided only one reinforcing frame 9 between side frames 7 and 8. An end of reinforcing frame 9 located on side frame 7 side is fixed to side frame 7, and an end of reinforcing frame 9 located on side frame 8 side is fixed to side frame 8.

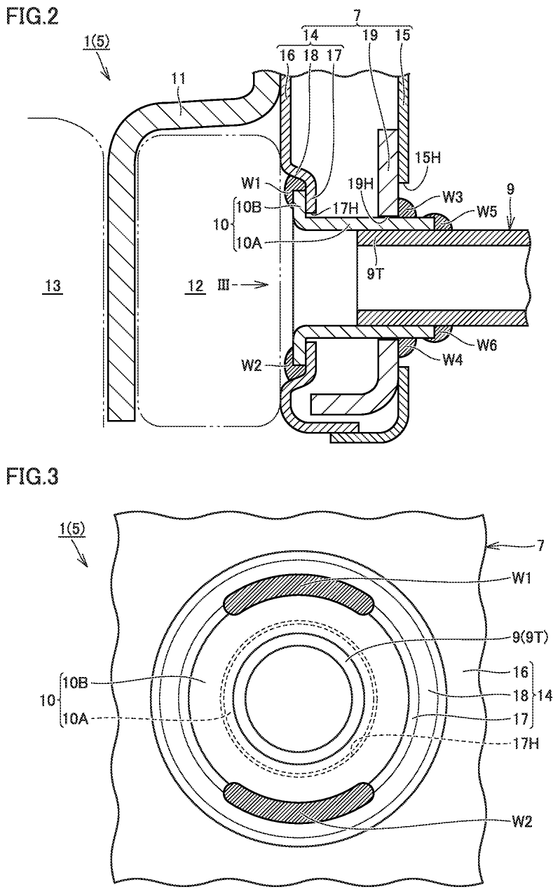

The following description will focus on and discuss a mode in which the end of reinforcing frame 9 located on side frame 7 side (an end 9T shown in FIG. 2) is fixed to side frame 7 via collar 10. FIG. 2 is a cross-sectional view taken along line II-II in a direction of arrows in FIG. 1, showing a cross-sectional structure of side frame 7, collar 10 and the like included in seat back frame 5 of vehicle seat 1. FIG. 3 shows collar 10 and the like viewed in a direction indicated by an arrow III in FIG. 2.

### (Side Frame 7)

Referring to FIGS. 1 to 3 (mainly FIG. 2), side frame 7 of the present embodiment has a first panel member 14, a second panel member 15 and a third panel member 19. First panel member 14, second panel member 15 and third panel member 19 are each formed of a pressed metal plate of iron and the like, and are provided such that planes constituting these members are mostly along a forward-rearward direction.

First panel member 14 and second panel member 15 are provided to face each other in the seat width direction, with first panel member 14 located outward and second panel member 15 located inward in the seat width direction (see FIG. 1). First panel member 14 and second panel member 15 are joined to each other to form a cross section in a closed annular shape (see FIG. 2).

Third panel member 19 is located at a lower portion of first panel member 14 and second panel member 15 (see FIG. 1), and third panel member 19 is supported by a cushion frame and the like not shown in the figure via a recliner and the like. Third panel member 19 has a thickness greater than that of each of first panel member 14 and second panel member 15. As shown in FIG. 2, third panel member 19 of the present embodiment is located outward of second panel member 15 in the seat width direction (the side on which first panel member 14 is located as viewed from second panel member 15). Third panel member 19 and second panel member 15 are joined to each other via a welded portion, a fastened portion and the like not shown in the figure.

First panel member 14 constituting side frame 7 has a first plate-like portion 16, a second plate-like portion 17, and a step forming portion 18 connecting these portions. First plate-like portion 16 constitutes an outer portion of side frame 7 in the seat width direction, and extends planarly in a direction crossing (in this case, substantially orthogonal to) the seat width direction.

Armrest holding bracket 11, air bag unit 12 and armrest 13 are provided at positions outward of first plate-like portion 16 in the seat width direction (FIG. 2). Armrest holding bracket 11 and air bag unit 12 are provided outward of a tubular portion 10A of collar 10 which will be described later in the seat width direction. If tubular portion 10A is virtually displaced outward in the seat width direction, a virtual image of tubular portion 10A crosses (interlinks with) armrest holding bracket 11 and air bag unit 12.

Second plate-like portion 17 also constitutes the outer portion of side frame 7 in the seat width direction, and extends planarly in the direction crossing (in this case, substantially orthogonal to) the seat width direction. Second plate-like portion 17 is formed to be located inward of first plate-like portion 16 in the seat width direction, and is provided with a through hole 17H. In the present embodiment, first plate-like portion 16 and second plate-like portion 17 are integrally provided at first panel member 14 constituting side frame 7, and second plate-like portion 17 is formed by providing a recess (step forming portion 18) in a portion of first plate-like portion 16.

As shown in FIG. 3, in the present embodiment, step forming portion 18 forms an annular shape in side view, and second plate-like portion 17 forms an annular shape inward of step forming portion 18 in a radial direction. Through hole 17H in a circular shape is formed in the inner side of second plate-like portion 17 in the radial direction.

### (Collar 10)

In vehicle seat 1, collar 10 is used as a member for fixing end 9T of reinforcing frame 9 located on side frame 7 side to side frame 7. As shown in FIGS. 2 and 3, collar 10 has tubular portion 10A and a rib-shaped portion 10B. In the present embodiment, tubular portion 10A has a cylindrical shape, and rib-shaped portion 10B has an annularly extending disc shape.

Third panel member 19 is provided with a through hole 19H (FIG. 2), and second panel member 15 is provided with a through hole 15H. Through holes 17H, 19H and 15H are substantially coaxially disposed (disposed such that the central axes of the respective holes substantially coincide with one another). Tubular portion 10A of collar 10 is inserted in through holes 17H, 19H and 15H and disposed to extend in the seat width direction, and has end 9T of reinforcing frame 9 inserted therein.

Rib-shaped portion 10B of collar 10 is provided as a flange at an outer end of tubular portion 10A in the seat width direction, and is disposed outward of second plate-like portion 17 in the seat width direction. In the present embodiment, an outer surface of rib-shaped portion 10B in the seat width direction is located inward of first plate-like portion 16 in the same direction (on the right side in the sheet of FIG. 2), and the entire rib-shaped portion 10B is accommodated in a concave space formed by second plate-like portion 17 and step forming portion 18.

### (Welded Portions W1 to W6)

As shown in FIGS. 2 and 3, tubular portion 10A and/or rib-shaped portion 10B of collar 10 are welded to second plate-like portion 17. In the present embodiment, welded portions W1 and W2 are formed outward of second plate-like portion 17 in the seat width direction in order to weld rib-shaped portion 10B to second plate-like portion 17 (and step forming portion 18).

A portion of second plate-like portion 17 that is located above tubular portion 10A and an upper portion of rib-shaped portion 10B are joined to each other via welded portion W1. A portion of second plate-like portion 17 that is located below tubular portion 10A and a lower portion of rib-shaped portion 10B are joined to each other via welded portion W2. Welded portions W1 and W2 are formed to be located opposite each other in a circumferential direction. To weld rib-shaped portion 10B to second plate-like portion 17, there may be provided two or more welded portions between them.

To weld tubular portion 10A to third panel member 19, welded portions W3 and W4 are formed inward of third panel member 19 in the seat width direction (on the right side in the sheet of FIG. 2). A portion of third panel member 19 that is located above tubular portion 10A and an upper portion of tubular portion 10A are joined to each other via welded portion W3. A portion of third panel member 19 that is located below tubular portion 10A and a lower portion of tubular portion 10A are joined to each other via welded portion W4. Welded portions W3 and W4 are formed to be located opposite each oilier in the circumferential direction. To weld tubular portion 10A to third panel member 19, there may be provided two or more welded portions between them.

To weld tubular portion 10A to reinforcing frame 9, welded portions W5 and W6 are formed at an inner end of tubular portion 10A in the seat width direction (on the right side in the sheet of FIG. 2). A portion of tubular portion 10A that is located above reinforcing frame 9 and an upper portion of reinforcing frame 9 are joined to each other via welded portion W5. A portion of tubular portion 10A that is located below reinforcing frame 9 and a lower portion of reinforcing frame 9 are joined to each other via welded portion W6. Welded portions W5 and W6 are formed to be located opposite each other in the circumferential direction. To weld tubular portion 10A to reinforcing frame 9, there may be provided two or more welded portions between them.

### Comparative Example

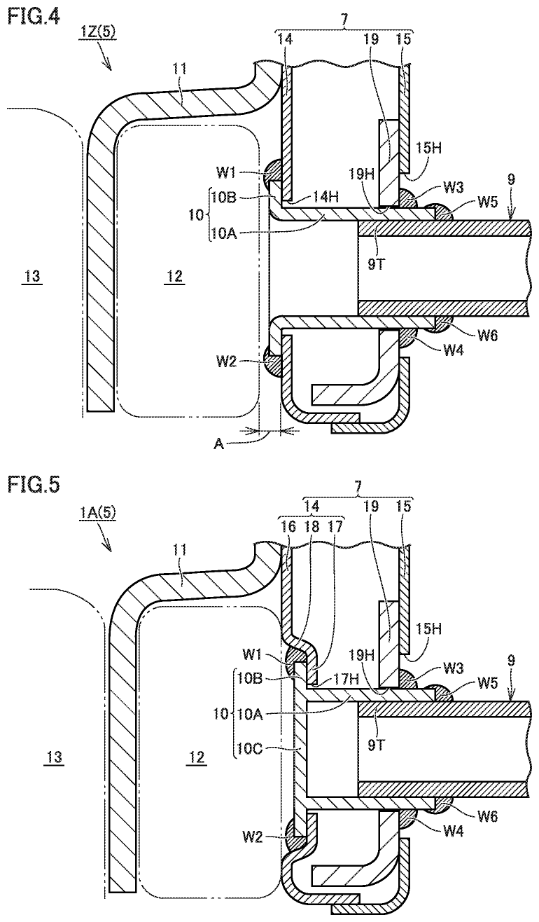

Function and effect of the first embodiment above are described in comparison to a comparative example below. FIG. 4 is a cross-sectional view showing side frame 7, collar 10 and the like included in a vehicle seat 1Z in the comparative example, and corresponds to FIG. 2 in the first embodiment.

In vehicle seat 1Z of the comparative example, first panel member 14 is not provided with portions corresponding to step forming portion 18 and second plate-like portion 17. Rib-shaped portion 10B of collar 10 is disposed outward of a plate-like portion extending along the forward-rearward direction of first panel member 14 (a portion corresponding to first plate-like portion 16 in the first embodiment) in the seat width direction, and tubular portion 10A of collar 10 is inserted in a through hole 14H provided in this plate-like portion.

The comparative example does not employ the configuration in which rib-shaped portion 10B of collar 10 is disposed outward of second plate-like portion 17 in the seat width direction. This causes air bag unit 12 and armrest 13 to be disposed more outward in the seat width direction by a dimension A (FIG. 4) than in the first embodiment. That is, in the configuration of the comparative example, the structure for fixing reinforcing frame 9 to side frame 7 does not have the configuration in which rib-shaped portion 10B of collar 10 is disposed outward of second plate-like portion 17 in the seat width direction, and as a result, the structure imposes layout constraints on the structure for fixing air bag unit 12 to side frame 7 and the structure for fixing armrest 13 to side frame 7.

In contrast, in vehicle seat 1 of the first embodiment, first panel member 14 is provided with step forming portion 18 and second plate-like portion 17 (FIG. 2), and rib-shaped portion 10B of collar 10 is provided outward of second plate-like portion 17 in the seat width direction. As second plate-like portion 17 is formed to be located inward of first plate-like portion 16 in the seat width direction, rib-shaped portion 10B can be disposed more inward in the seat width direction than in the comparative example above. According to the configuration of the first embodiment, therefore, there can be provided vehicle seat 1 having a configuration capable of reducing layout constraints imposed on peripheral components when fixing reinforcing frame 9 to side frame 7, as compared to the comparative example above.

### Second Embodiment

FIG. 5 is a cross-sectional view showing side frame 7, collar 10 and the like included in a vehicle seat 1A in a second embodiment, and corresponds to FIG. 2 in the first embodiment. In the first embodiment described above (see FIG. 2), rib-shaped portion 10B of collar 10 has an open inner side in the radial direction, and the outer end of tubular portion 10A in the seat width direction is not closed.

As shown in FIG. 5, collar 10 may have a closed portion 10C. Closed portion 10C closes the outer end of tubular portion 10A in the seat width direction. An outer surface of closed portion 10C in the seat width direction is located inward of first plate-like portion 16 in the same direction (on the right side in the sheet of FIG. 5), and the entire closed portion 10C is accommodated in the concave space formed by second plate-like portion 17 and step forming portion 18. Function and effect similar to those of the first embodiment described above can also be obtained by this configuration.

### Third Embodiment

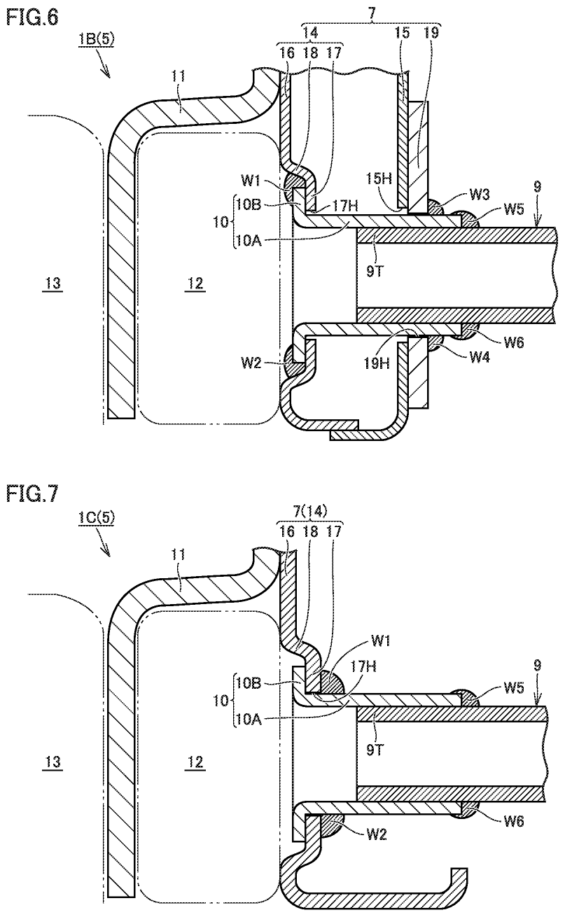

FIG. 6 is a cross-sectional view showing side frame 7, collar 10 and the like included in a vehicle seat 1B in a third embodiment, and corresponds to FIG. 2 in the first embodiment. In the first embodiment described above (see FIG. 2), third panel member 19 is disposed outward of second panel member 15 in the seat width direction (the side on which first panel member 14 is located as viewed from second panel member 15).

As shown in FIG. 6, third panel member 19 may be disposed inward of second panel member 15 in the seat width direction (the side opposite the side on which first panel member 14 is located as viewed from second panel member 15). In the third embodiment, tubular portion 10A of collar 10 is inserted successively in through holes 17H, 15H and 19H and disposed to extend in the seat width direction, and has end 9T of reinforcing frame 9 inserted therein. Third panel member 19 may constitute a so-called lower arm of side frame 7, or a so-called upper arm of side frame 7. Function and effect similar to those of the first embodiment described above can also be obtained by this configuration.

### Fourth Embodiment

FIG. 7 is a cross-sectional view showing side frame 7, collar 10 and the like included in a vehicle seat 1C in a fourth embodiment, and corresponds to FIG. 2 in the first embodiment. In the first embodiment described above (see FIG. 2), side frame 7 has first panel member 14, second panel member 15 and third panel member 19, with first panel member 14 and second panel member 15 joined to each other to form a cross section in a closed annular shape (see FIG. 2).

As shown in FIG. 7, side frame 7 does not need to have members corresponding to second panel member 15 and third panel member 19. Alternatively, side frame 7 does not need to have members corresponding to second panel member 15 and third panel member 19 at the position of collar 10. That is, the technical concept disclosed in each embodiment described above is applicable to any mode as long as side frame 7 at least includes a portion corresponding to first panel member 14 at the fixed position of collar 10.

In the first embodiment, rib-shaped portion 10B is welded to an outer surface of second plate-like portion 17 in the seat width direction, in the fourth embodiment (FIG. 7), rib-shaped portion 10B is not welded to second plate-like portion 17, and tubular portion 10A is welded to an inner surface of second plate-like portion 17 in the seat width direction (welded portions W1 and W2). Function and effect similar to those of the first embodiment described above can also be obtained by this configuration.

### Other Embodiments

In each embodiment described above, both armrest holding bracket 11 and air bag unit 12 are provided outward of tubular portion 10A of collar 10 in the seat width direction. This configuration is not essential. Only one of armrest holding bracket 11 and air bag unit 12 may be provided, or another device may be provided, or nothing may be provided outward of tubular portion 10A of collar 10 in the seat width direction.

The description of each embodiment above has focused on and discussed a mode in which the end of reinforcing frame 9 located on side frame 7 side (end 9T shown in FIG. 2) is fixed to side frame 7 via collar 10. The technical concept described in each embodiment above is also applicable to a mode in which the end of reinforcing frame 9 located on side frame 8 (FIG. 1) side is fixed to side frame 8 via a collar.

The description of each embodiment above has focused on and discussed lower reinforcing frame 9 of two reinforcing frames 9 (FIG. 1). The technical concept described in each embodiment above is also applicable to upper reinforcing frame 9 of two reinforcing frames 9.

The description of each embodiment above has been provided based on side frames 7 and 8 constituting seat back frame 5 together with upper frame 6, as well as reinforcing frame 9. The technical concept described in each embodiment above is not limited to be applied to seat back frame 5, but is also applicable to a seat frame forming a framework of seat cushion 2. The technical concept described in each embodiment above is not limited to be applied to a car seat, but is applicable to any vehicle seat.

A summary of contents of the present disclosure described above is given as follows.

A vehicle seat based on the present disclosure includes: a first side frame and a second side frame spaced from each other in a seat width direction; a reinforcing frame provided to bridge between the first side frame and the second side frame; and a collar for fixing an end of the reinforcing frame located on the first side frame side to the first side frame, the first side frame having a first plate-like portion constituting an outer portion of the first side frame in the seat width direction, and extending planarly in a direction crossing the seat width direction, and a second plate-like portion formed to be located inward of the first plate-like portion in the seat width direction, and provided with a through hole, the collar having a tubular portion inserted in the through hole and disposed to extend in the seat width direction, and having the end of the reinforcing frame inserted therein, and a rib-shaped portion provided at an outer end of the tubular portion in the seat width direction, and disposed outward of the second plate-like portion in the seat width direction, and the tubular portion and/or the rib-shaped portion being welded to the second plate-like portion.

Preferably, in the vehicle seat described above, the first side frame has a first panel member, the first plate-like portion and the second plate-like portion are integrally provided at the first panel member constituting the first side frame, and the second plate-like portion is formed by providing a recess in a portion of the first plate-like portion.

Preferably, in the vehicle seat described above, the first side frame further has a second panel member provided to face the first panel member from inward in the seat width direction, and the first panel member and the second panel member are joined to each other to form a cross section in a closed annular shape.

Preferably, in the vehicle seat described above, the first side frame further has a third panel member disposed inward or outward of the second panel member in the seat width direction, and the tubular portion is disposed to extend through the second panel member and the third panel member in the seat width direction, and is welded to the third panel member.

Preferably, the vehicle seat described above further includes an upper frame connecting an upper end of the first side frame and an upper end of the second side frame, in which the first side frame and the second side frame constitute a back frame together with the upper frame.

Preferably, in the vehicle seat described above, an armrest holding bracket and/or an air bag unit are provided outward of the tubular portion in the seat width direction.

According to the configuration described above, there can be provided a vehicle seat having a configuration capable of reducing layout constraints imposed on peripheral components when fixing a reinforcing frame to side frames.

Although the embodiments of the present disclosure have been described and illustrated in detail, it is clearly understood that the same is by way of illustration and example only and is not to be taken by way of limitation. It is therefore intended that the scope of the present invention is defined by claims, and encompasses all modifications and variations equivalent in meaning and scope to the claims.

What is claimed is:

1. A vehicle seat comprising:
a first side frame and a second side frame spaced from each other in a seat width direction;
a reinforcing frame provided to bridge between the first side frame and the second side frame; and
a collar for fixing an end of the reinforcing frame located on the first side frame side to the first side frame,
the first side frame having
a first plate-like portion constituting an outer portion of the first side frame in the seat width direction, and extending planarly in a direction crossing the seat width direction, and
a second plate-like portion formed to be located inward of the first plate-like portion in the seat width direction, and provided with a through hole,
the collar having
a tubular portion inserted in the through hole and disposed to extend in the seat width direction, and having the end of the reinforcing frame inserted therein, and
a rib-shaped portion provided at an outer end of the tubular portion in the seat width direction, and disposed outward of the second plate-like portion in the seat width direction, and
the tubular portion and/or the rib-shaped portion being welded to the second plate-like portion.

2. The vehicle seat according to claim 1, wherein
the first side frame has a first panel member,
the first plate-like portion and the second plate-like portion are integrally provided at the first panel member constituting the first side frame, and
the second plate-like portion is formed by providing a recess in a portion of the first plate-like portion.

3. The vehicle seat according to claim 2, wherein
the first side frame further has a second panel member provided to face the first panel member from inward in the seat width direction, and
the first panel member and the second panel member are joined to each other to form a cross section in a closed annular shape.

4. The vehicle seat according to claim 3, wherein
the first side frame further has a third panel member disposed inward or outward of the second panel member in the seat width direction, and
the tubular portion is disposed to extend through the second panel member and the third panel member in the seat width direction, and is welded to the third panel member.

5. The vehicle seat according to claim 4, further comprising an upper frame connecting an upper end of the first side frame and an upper end of the second side frame, wherein
the first side frame and the second side frame constitute a back frame together with the upper frame.

6. The vehicle seat according to claim 1, wherein
an armrest holding bracket and/or an air bag unit are provided outward of the tubular portion in the seat width direction.
